(19) United States
(12) Patent Application Publication
(10) Pub. No.: US 2010/0324727 A1
(43) Pub. Date: Dec. 23, 2010

(54) METHOD AND SYSTEM FOR DISPENSING BANKNOTES FROM AN AUTOMATED TELLER MACHINE

(75) Inventor: Yves Eonnet, Saint- Nom-la-Breteche (FR)

Correspondence Address: OBLON, SPIVAK, MCCLELLAND MAIER & NEUSTADT, L.L.P., 1940 DUKE STREET, ALEXANDRIA, VA, 22314, US

(73) Assignees: Tagattitude, Rocquencourt (FR); Casyope, La Verriere (FR)

(21) Appl. No.: 12/866,626

(22) PCT Filed: Feb. 9, 2009
(86) PCT No.: PCT/FR2009/050197

§ 371 Date: Aug. 6, 2010

(30) Foreign Application Priority Data
Feb. 8, 2008 (FR) 0800661

(51) Int. Cl. G06Q 40/00; G06F 19/00

(52) U.S. Cl. 700/237; 705/43

(57) ABSTRACT

This method for dispensing banknotes from an automated teller machine includes, after authentication of a user, a step (122) of dispensing, by an automated teller machine, of banknotes corresponding to a predetermined amount.

It involves the establishment (104) of a mobile communication channel between a portable apparatus of the user close to the automated teller machine, and an authentication unit; downloading (110), by the automated teller machine, of a digital code from the authentication unit; transmission (114), by the portable apparatus, via the secured mobile communication channel, to the authentication unit, of a sound signal generated from the digital code and transmitted by the automated teller machine; authentication (118) of the user by the authentication unit; and transmission (122) to the automated teller machine of an instruction to activate the automaton to dispense banknotes corresponding to the predetermined amount.

The present invention concerns a method and a system for dispensing banknotes from an automated teller machine. It also concerns a method for transferring money between first and second users using such a method for dispensing banknotes.

The invention applies more specifically to a method for dispensing banknotes from an automated teller machine, including a step for authenticating a user of the automated teller machine, and a step of dispensing, through an automaton of the automated teller machine, of banknotes corresponding to a predetermined amount.

In general authentication consists for a user of inserting a bank card in a slot of the automated teller machine, and in entering a four-figure secret code associated with this bank card. The user then chooses an amount and receives from the automated teller machine automaton banknotes corresponding to the chosen amount.

This authentication technique, although very simple, requires that a secret code is memorized, and that the user has a bank card with them to withdraw money using the automated teller machine. Certain persons, fearing that they will forget their secret code, even run the risk of writing it on a piece of paper which they keep on them with the bank card, making them particularly vulnerable to thefts. In addition, the bank card is yet another object, in addition to all those which the user already has on them, which can be lost or stolen. When such a situation occurs, moreover, it is imperative that a bank stop payment procedure is undertaken in order that no third party is able to use the lost or stolen card.

It may therefore be desired to design a system and/or a method for dispensing banknotes from an automated teller machine which allows the abovementioned problems and constraints to be overcome.

The purpose of the invention is therefore a method for dispensing banknotes from an automated teller machine, including a step of authenticating a user of the automated teller machine and a step of dispensing, by an automatic banknote automaton, of banknotes corresponding to a predetermined amount characterized in that it contains the following steps:
establishment of a communication channel, in a secured mobile telephone network, between a portable apparatus of the user located near the automated teller machine, and an authentication unit connected to the automated teller machine via a data transmission network,
downloading, by the automated teller machine, via the data transmission network, of a digital code from the authentication unit,
transmission, by the portable apparatus, via the secured mobile communication channel, to the authentication unit, of a sound signal generated from the digital code and transmitted by the automated teller machine,
authentication of the user by the authentication unit using the sound signal received via the secured mobile communication channel and an identifier of the user's portable apparatus,
transmission to the automated teller machine of an instruction to activate the automaton to dispense banknotes corresponding to the predetermined amount.

This method for dispensing banknotes is therefore particularly simple to use since the user has merely to establish a mobile telephone communication with the authentication unit, and to put their portable apparatus near the automated teller machine in order to authentify themselves and activate the dispensation of the banknotes. Since portable apparatuses are very widely used at the current time, it is advantageous to substitute them for bank cards, and to restrict by this means the objects which can be lost or stolen which a user is obliged to carry on them.

Moreover, it is no longer necessary to enter a specific secret code, given that the authentication of the method for dispensing banknotes according to the invention relies firstly on the security of the secured mobile telephone network and, secondly, on the fact that the portable apparatus is one of the user's personal devices. Indeed, when the authentication unit receives the sound signal via the mobile communication channel, it checks that it was transmitted from the personal portable apparatus of a user necessarily located near the automated teller machine having received the digital code.

Optionally, a method for dispensing banknotes according to the invention includes a prior step of receipt by the authentication unit of an instruction to dispense a transaction amount associated with a transaction identifier, and the step of authentication of the user by the authentication unit includes:
a comparison of the identifier of the user's portable apparatus with the transaction identifier, and
if the two identifiers match, transmission of the instruction to activate the automaton, where this instruction includes an indication of the transaction amount as the predetermined amount corresponding to the banknotes to be supplied by the automaton.

Optionally, the instruction to dispense a transaction amount associated with a transaction identifier also includes an identifier of the bank account to be debited by an amount corresponding to the transaction amount.

Optionally, the identifier of the bank account to be debited is an identifier of a withdrawal and payment bank card associated with the bank account.

Another object of the invention is a method for transferring money between a first user and a second user, comprising the following steps:
transmission, by the first user, from an access terminal connected to an authentication unit via a data transmission network, of an instruction to dispense a transaction amount associated with a transaction identifier corresponding to an identifier of a portable apparatus of the second user, followed by
use of a method for dispensing banknotes from an automated teller machine as described above, by the second user located near the automated teller machine.

Optionally, a method for transferring money according to the invention comprises a prior step of inserting a bank card in a card reader connected to the access terminal, for transmission of an identifier of this bank card with the instruction to dispense the transaction amount.

Optionally, a method for transferring money according to the invention comprises a step of transmission, by the automated teller machine, to the authentication unit, of a confirmation that the banknotes corresponding to the predetermined amount have indeed been supplied to the second user, followed by a step of transmission, by the authentication unit, to the first user, of a confirmation of the money transfer.

Optionally, the confirmation of the money transfer includes a message containing information of a cost of the money transfer and/or a photograph or video taken using a device associated with the automated teller machine at the time when the banknotes corresponding to the predetermined amount were dispensed to the second user.

Optionally, the confirmation of the money transfer is transmitted to the access terminal, or to a predetermined portable apparatus of the first user.

Finally, another object of the invention is a system for dispensing banknotes comprising an automated teller machine for authentication of a user of the automated teller machine and an automaton of the automated teller machine for the dispensing of banknotes corresponding to a predetermined amount, characterized in that it also comprises:
means for establishment of a communication channel, in a secured mobile telephone network, between a portable apparatus of the user located near the automated teller machine, and an authentication unit connected to the automated teller machine via a data transmission network,
means for downloading, by the automated teller machine, via the data transmission network, of a digital code from the authentication unit,
means for transmission, by the portable apparatus, via the secured mobile communication channel, to the authentication unit, of a sound signal generated from the digital code and transmitted by the automated teller machine,
means for authenticating the user by the authentication unit using the sound signal received via the secured mobile communication channel and an identifier of the user's portable apparatus,
means for transmitting to the automated teller machine an instruction to activate the automaton to dispense banknotes corresponding to the predetermined amount.

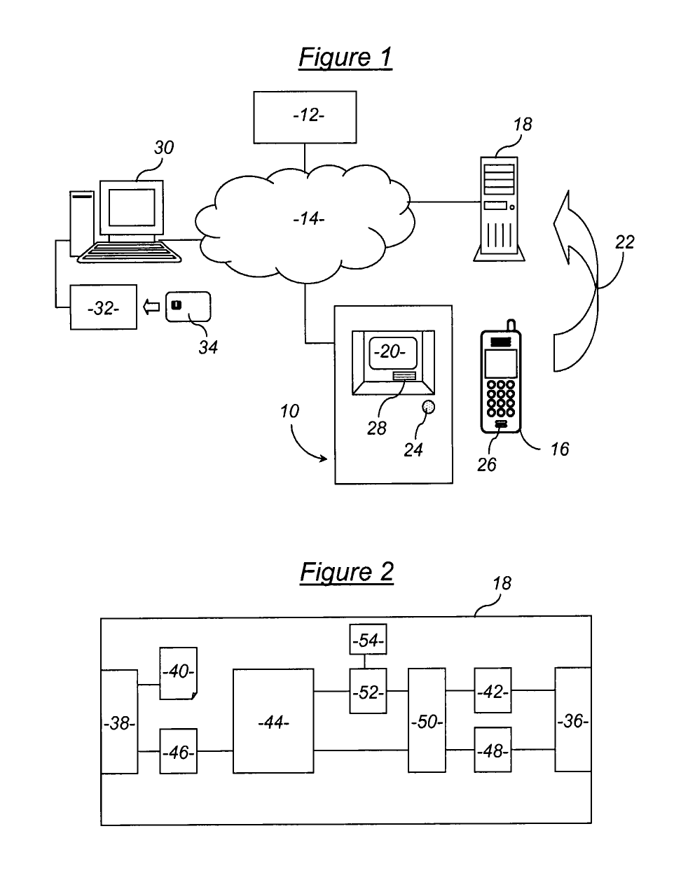

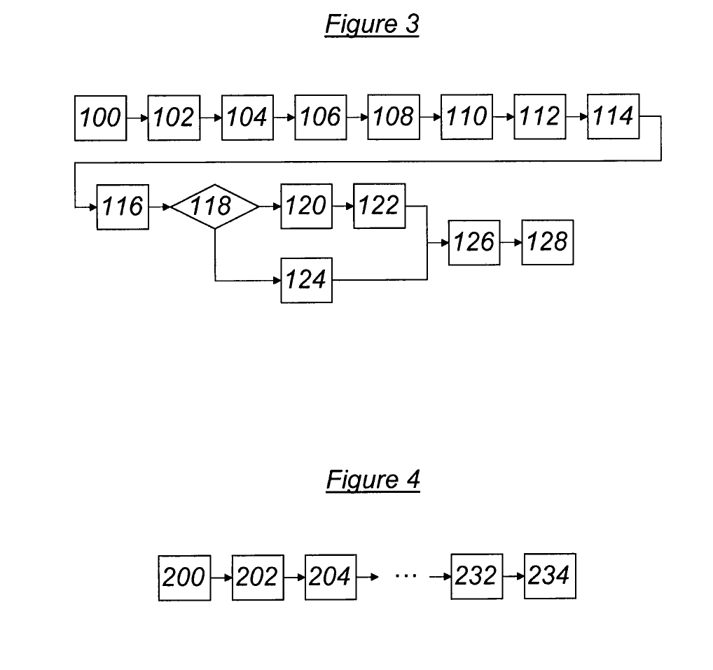

The invention will be better understood by means of the following description, given solely as an example, and made in reference to the appended illustrations, in which:
FIG. 1 represents diagrammatically the general structure of a system for dispensing banknotes or for transferring money according to an embodiment of the invention;
FIG. 2 represents in detailed fashion the general structure of an authentication unit of the system in FIG. 1;
FIG. 3 illustrates the successive steps of a method for dispensing banknotes according to an embodiment of the invention, which can be used by the system of FIG. 1;
FIG. 4 illustrates the successive steps of a method for transferring money according to an embodiment of the invention, which can be used by the system of FIG. 1.

The system represented in FIG. 1 may be used for dispensing banknotes from an automated teller machine 10 to a user wishing to withdraw a predetermined amount from a bank account, with the authorization of a bank entity 12 connected to the automated teller machine 10 via a secure data transmission network 14.

In accordance with an embodiment of the invention, the user owns a portable apparatus 16. In the example described here, this portable apparatus is a cell phone complying with the GSM standard, an identifier of which is, for example, the call number.

In the use described here, when the user seeks to deduct an amount from the bank entity 12, for example by pressing a dedicated key of the automated teller machine 10, they are in fact directed to an authentication unit 18, and receive, on a screen 20 of the automated teller machine 10, a welcome page sent from this authentication unit 18. This welcome page contains a message asking the user to enter a telephone number of the authentication unit 18, so as to establish a communication channel 22, in a secured mobile telephone network, between the portable apparatus 16 and the authentication unit 18.

In accordance with an embodiment of the invention, the authentication unit 18 is suitable for obtaining the telephone number of the portable apparatus 16 when communication channel 22 is established, and for checking that a sound signal which it receives from this portable apparatus 16 has indeed been generated and transmitted by the automated teller machine 10 from a digital audio file created by the authentication unit 18.

The sound signal is transmitted by the automated teller machine 10 using a loudspeaker 24, and is picked up by a microphone 26 of the portable apparatus 16 when the latter is positioned near the automated teller machine 10.

When obtained by the authentication unit 18, the telephone number of the portable apparatus 16 is transmitted to the bank entity 12 as the user's identifier. If applicable, the bank entity 12 authenticates the user of the portable apparatus 16 and authorizes an account associated with the transmitted identifier to be debited. An instruction to activate an automaton of the automated teller machine, partially illustrated in FIG. 1 by reference 28, for the dispensing of banknotes corresponding to the predetermined amount, is then transmitted to the automated teller machine 10, either by the authentication unit 18, or by the bank entity 12.

The system represented in FIG. 1 can also be used for a money transfer, between a first user transmitting this money and a second user receiving this money, via the automated teller machine 10. This money is intended to be deducted from a bank account of the first user, with authorization of the bank entity 12, which is the account manager, and then to be supplied to the second user via the automated teller machine 10, using the second user's portable apparatus 16.

For this money transfer application, the system represented in FIG. 1 contains elements in addition to those which have been described above. Indeed, in accordance with an embodiment of the invention, the first user connects to the data transmission network 14, using an access terminal 30, in order to transmit an instruction to dispense a transaction amount associated with a transaction identifier corresponding to the abovementioned identifier of the portable apparatus 16 of the second user. This instruction is transmitted to the bank entity 12 and/or to the authentication unit 18.

The access terminal 30 is, for example, a traditional microcomputer disposed in the home of the first user. It may also be fitted with a card reader 32 capable of receiving a bank card 34 of the first user to validate the money transfer operation and/or to identify the bank account to be debited with an amount relating to the transaction.

Since the transaction identifier is the identifier of the portable apparatus 16 of the second user, the latter can then ask the bank entity 12 that the transaction amount is deducted, via the automated teller machine, as described previously for dispensing banknotes.

In order to add an additional security, the first user can compose a secret transaction code, which is transmitted with the instruction to dispense the transaction amount to the owner of the portable apparatus identified by the transaction identifier, of which they inform the second user. Thus, the second user can go to the automated teller machine and start by entering this secret transaction code.

FIG. 2 describes in detail the general structure of the authentication unit 18.

This authentication unit 18 comprises a module 36 for receiving a call complying with the GSM standard, hereinafter called GSM module 36. This GSM module 36 allows the authentication unit 18 to establish the secured mobile communication channel 22 with the portable apparatus 16.

In another embodiment, GSM module 36 can be replaced by a communication module complying with another known secured mobile telephony standard, for example the UMTS or CDMA protocol.

The authentication unit 18 also has a network interface 38. This network interface 38 has, more specifically, hardware and software means to communicate with another item of equipment connected to the data transmission network 14, namely, in particular, a network card and software implementing, for example, a communication protocol of the TCP/IP type if the data transmission network 14 is at least partially the Internet network.

As indicated above, when a user seeks to deduct an amount from the bank entity 12 via the automated teller machine 10, they are in fact directed to the authentication unit 18, and receive on the screen 20 a welcome page 40 from this authentication unit 18. This welcome page is, for example, a page presenting data in HTML format, including the telephone number of the GSM module 36.

The authentication unit 18 also contains means 42 for obtaining, from a GSM frame received by the GSM module 36 from the portable apparatus 16 with which it has established the communication channel 22, the telephone number of this portable apparatus, considered for this embodiment of the invention as its identifier.

The authentication unit 18 described here also contains means 44 for generating a digital code relating to the pending transaction (i.e. dispensing of banknotes or money transfer). More precisely, these means 44 can include means for random generation of a digital code, for example a sequence of DTMF codes, and for memorization of this randomly generated digital code in relation with an identifier of a secure connection between the authentication unit 18, the bank entity 12 and the automated teller machine 10 for the pending transaction. For the sake of simplicity, it will be supposed in the example described here that, following the establishment of the secured mobile communication channel 22, the DTMF sequence “8, 7, 3, 2, 1, 2, 4” is generated and memorized by the means 44.

The authentication unit 18 also contains means 46 for creating a self-executing digital audio file from a sequence of DTMF codes. Thus, in the example described here, the means 46 for creating a digital audio file are suitable for creating a digital audio file in .wav format which, when executed, generates the DTMF sequence “8, 7, 3, 2, 1, 2, 4”.

Thus, when the user of the automated teller machine 10 calls the authentication unit 18 as indicated by the welcome page 40, the network interface 38 allows the downloading of the abovementioned digital audio file by the automated teller machine 10.

As described above, on receipt of this file the automated teller machine 10 automatically transmits the DTMF sequence “8, 7, 3, 2, 1, 2, 4” through its loudspeaker 24. Since microphone 26 of portable apparatus 16 is located near this loudspeaker, the DTMF code “8, 7, 3, 2, 1, 2, 4” is transmitted via the previously established secured mobile communication channel 22 to the GSM module 36 of the authentication unit 18.

The voice data received by the GSM module 36 is sent to sampling means 48 of the authentication unit 18. These sampling means 48 are more specifically designed to recognize, in the voice data received by the GSM module 36, frequencies characteristic of DTMF codes. Thus, if DTMF sequence “8, 7, 3, 2, 1, 2, 4” is received by the GSM module 36, the sampling means 48 are able to provide as output the sequence of successive FIGS. 8, 7, 3, 2, 1, 2 and 4.

These figures are supplied by the sampling means 48 to identification means 50, which are designed to determine, if applicable and using the data memorized in the means 44, the identifier of the secure connection associated with this sequence of figures.

After validation of the sampled sequence of figures, the identification means 50 transmit, to the bank entity 12, the identifier of the portable apparatus 16 obtained by the acquisition means 42. On receipt of this identifier the bank entity 12 is able to authenticate the user owning the portable apparatus 16, and to authorize dispensation of the banknotes corresponding to the predetermined amount in the context of the pending transaction. If the authentication fails the identification means 50 transmit, to the bank entity 12, information representing an authentication failure.

Authentication unit 18 described here also contains means 52 for destroying the DTMF sequence memorized in file 40. These means for destruction 52 are, in particular, designed to destroy the abovementioned DTMF sequence after a predetermined period, which starts when the DTMF sequence is generated by the generation means 44. To this end, the means of destruction 52 cooperate with a clock 54. They are also able to destroy the DTMF sequence when ordered by the identification means 50.

The successive steps of a method for dispensing banknotes in accordance with the invention will now be described in detail with reference to FIG. 3.

In the embodiment envisaged here, when a user wishes to deduct a predetermined amount from a bank account using an automated teller machine 10, with the authorization of a bank entity 12 connected to the automated teller machine 10 via the secure data transmission network 14, the bank entity 12 establishes a secure connection with the automated teller machine 10 and the authentication unit 18 during a first step 100, and generates a corresponding secure connection identifier. It transmits this secure connection identifier to the authentication unit 18.

During a following step 102, the user receives, on the screen 20 of the automated teller machine 10, the welcome page 40 from the authentication unit 18, informing them of the telephone number to dial in order to authenticate themselves using their portable apparatus 16.

Thus, during a step 104, the user dials this telephone number and establishes the secured mobile communication channel 22 between their portable apparatus 16 and the authentication unit 18.

During a step 106 the authentication unit 18 randomly generates and memorizes a digital code which, for example, takes the form of the abovementioned DTMF sequence. It associates this digital code with the secure connection identifier which it has received from the bank entity 12.

In a following step 108, it creates a self-executing digital audio file, for example in .wav format, from the DTMF sequence. More specifically, the digital audio file may be designed such that its execution generates the DTMF codes of the DTMF sequence one after another.

Then, in a step 110, the digital audio file is transmitted by the authentication unit 18 to the automated teller machine 10, for example following a command of the user who has been asked, by the screen of the automated teller machine 10, or directly by the authentication unit 18, via the secured mobile communication channel 22, to press a particular button.

In a step 112 the digital audio file is executed automatically in the automated teller machine, generating by this means a sound signal, namely the DTMF codes of the DTMF sequence, one after another. This sound signal is broadcast by the loudspeaker 24.

If the user brings the microphone 26 of the portable apparatus 16 sufficiently close to the loudspeaker 24 the sound signal transmitted by the loudspeaker is sent, in a step 114, to the authentication unit 18 over the secured mobile communication channel 22.

After receipt by the authentication unit 18 the sound signal is processed by the sampling means 48, and subsequently the digital code output from this process is compared with a set of digital codes memorized in the means 44 of the authentication unit 18, during a step 116. The comparison technique used is known to the skilled man in the art. It is used in particular in voice servers to identify a DTMF code entered on the keypad of a telephone calling these voice servers.

After this step an identification test is made by the authentication unit in a step 118. The result of this step is positive if the sound signal received and sampled is identical to the digital code memorized in relation with the secure connection identifier of the pending transaction. In this case this test is followed by a step 120, during which the authentication unit 18 transmits the identifier of the portable apparatus 16 to the bank entity 12. In the contrary case, if no sound signal corresponding to the DTMF sequence associated with the secure connection identifier of the pending transaction is received after a predetermined period, the result of the test is negative and followed by a step 124, during which the authentication unit 18 transmits data representing an authentication failure to the bank entity 12.

Step 120, transmission of the identifier of the portable apparatus 16 to the bank entity 12, is followed by a step 122, during which the bank entity 12 identifies the account to be debited with an amount corresponding to the predetermined amount desired by the user, and then authorizes the transmission of an instruction to activate the automaton 28 for the dispensing to the user of banknotes corresponding to the predetermined amount.

Be that as it may, steps 122 and 124 are followed by a step 126 of destruction of the DTMF sequence generated during step 106. This step 126 of destruction enables it to be ascertained that the random digital code generated during step 106 will not be used again, thereby strengthening the security of the method for dispensing banknotes according to the invention. This digital code is also preferably destroyed at the end of a predetermined period after its generation.

Optionally, destruction step 126 is followed by a step 128, during which the GSM module 36 of the authentication unit 18 transmits a message of the SMS type to the portable apparatus 16, which message contains, for example, the date and result of the abovementioned comparison step 116.

The successive steps of a method for transferring money in accordance with the invention will now be described in detail with reference to FIG. 4. As indicated with reference to FIG. 1, this money transfer occurs between a first user accessing the service from an access terminal 30, and a second user accessing the service from an automated teller machine 10 and using their portable apparatus 16.

In a first prior step 200, the first user connects to the data transmission network 14, using the access terminal 30, in order to transmit an instruction to dispense a transaction amount associated with a transaction identifier corresponding to the identifier of the portable apparatus 16 of the second user. This instruction is, for example, transmitted to the bank entity 12. It is transmitted with an identifier of the bank card 34 of the first user in such a way as to enable the bank entity to determine which account must be debited in this transaction. To strengthen the security of the transaction it may also be transmitted with it a secret transaction code, defined and entered by the first user, and it is then the responsibility of the latter to inform the second user of it.

Thus, during a step 202, the second user can go to the automated teller machine 10 to withdraw banknotes corresponding to the transaction amount indicated by the first user. In this step, they enter, for example, the secret transaction code supplied to them by the first user.

Validation of this secret code activates a succession of steps 204, 206, 208, 210, 212, 214, 216, 218, 220, 222, 224, 226, 228, 230, 232, reproducing the method of dispensing banknotes described above, and respectively corresponding to the successive steps 100 to 128. These steps will not therefore be described in detail.

It will however be noted that in step 226, corresponding to step 122, the bank entity determines the account to be debited, not using the identifier of the portable apparatus 16, but the identifier of the bank card 34, to debit, as expected, the bank account of the first user. Also during this step, or after this step when the second user has withdrawn their banknotes, the automated teller machine 10 can transmit to the authentication unit 18 a confirmation that the banknotes corresponding to the predetermined amount have indeed been supplied to the second user.

Optionally, during a step 234, which may follow step 232, but which can also be executed before it, the authentication unit transmits a confirmation of the money transfer to the first user.

This confirmation of the money transfer may include a message containing information of a cost of the money transfer and/or a photograph or video taken using a device (not represented in FIG. 1) associated with the automated teller machine 10 at the time when the banknotes corresponding to the predetermined amount were dispensed to the second user. It is, for example, transmitted to the access terminal 30, or to a predetermined portable apparatus of the first user, if this device is known to the authentication unit 18 or the bank entity 12.

It appears clearly that the system and methods described above allow withdrawals of money from an automated teller machine without any requirement for a person to have a bank card with them, and in which the authentication is accomplished using a portable apparatus.

1. A method for dispensing banknotes from an automated teller machine (10), including a step of authenticating a user of the automated teller machine and a step (122) of dispensing, by an automatic banknote automaton (28), of banknotes corresponding to a predetermined amount, characterized in that it contains the following steps:
establishment (104) of a communication channel (22), in a secured mobile telephone network, between a portable apparatus (16) of the user located near the automated teller machine (10), and an authentication unit (18) connected to the automated teller machine via a data transmission network (14),
downloading (110), by the automated teller machine (10), via the data transmission network (14), of a digital code from the authentication unit (18),
transmission (114), by the portable apparatus (16), via the secured mobile communication channel (22), to the authentication unit (18), of a sound signal generated from the digital code and transmitted by the automated teller machine (10),
authentication (118) of the user by the authentication unit (18) using the sound signal received via the secured mobile communication channel (22) and an identifier of the user's portable apparatus (16),
transmission (122) to the automated teller machine (10) of an instruction to activate the automaton (28) to dispense banknotes corresponding to the predetermined amount.

2. A method for dispensing banknotes from an automated teller machine (10) according to claim 1, including a prior step (200) of receipt by the authentication unit (18) of an instruction to dispense a transaction amount associated with a transaction identifier, and in which the step of authentication (118) of the user by the authentication unit includes:
a comparison (118) of the identifier of the user's portable apparatus with the transaction identifier, and
if the two identifiers match, transmission (122) of the instruction to activate the automaton (28), where this instruction includes an indication of the transaction amount as the predetermined amount corresponding to the banknotes to be supplied by the automaton.

3. A method for dispensing banknotes from an automated teller machine (10) according to claim 2, wherein the instruction to dispense a transaction amount associated with a transaction identifier also includes an identifier of the bank account to be debited with an amount corresponding to the transaction amount.

4. A method for dispensing banknotes from an automated teller machine (10) according to claim 3, wherein the identifier of the bank account to be debited is an identifier of a withdrawal and payment bank card (34) associated with the bank account.

5. A method for transferring money between a first user and a second user, including the following steps:
transmission (200), by the first user, from an access terminal (30) connected to an authentication unit (18) via a data transmission network (14), of an instruction to dispense a transaction amount associated with a transaction identifier corresponding to an identifier of a portable apparatus (16) of the second user, followed by
use of a method for dispensing banknotes from an automated teller machine (10) according to any one of the claims 2 to 4, by the second user located near the automated teller machine.

6. A method for transferring money according to claim 5, including a prior step of inserting a bank card (34) in a card reader (32) connected to the access terminal (30), for transmission of an identifier of this bank card with the instruction to dispense the transaction amount.

7. A method for transferring money according to claim 5 or 6, including a step (226) of transmission, by the automated teller machine (10), to the authentication unit (18), of a confirmation that the banknotes corresponding to the predetermined amount have indeed been supplied to the second user, followed by a step (234) of transmission, by the authentication unit (18), to the first user, of a confirmation of the money transfer.

8. A method for transferring money according to claim 7, wherein the confirmation of the money transfer includes a message containing information of a cost of the money transfer and/or a photograph or video taken using a device associated with the automated teller machine (10) at the time when the banknotes corresponding to the predetermined amount were dispensed to the second user.

9. A method for transferring money according to claim 7 or 8, wherein the confirmation of the money transfer is transmitted to the access terminal (30), or to a predetermined portable apparatus of the first user.

10. A system for dispensing banknotes comprising an automated teller machine (10) for authentication of a user of the automated teller machine and an automaton (28) of the automated teller machine for the dispensing of banknotes corresponding to a predetermined amount, characterized in that it also comprises:
means for establishment of a communication channel (22), in a secured mobile telephone network, between a portable apparatus (16) of the user located near the automated teller machine, and an authentication unit (18) connected to the automated teller machine (10) via a data transmission network (14),
means for downloading, by the automated teller machine (10), via the data transmission network (14), of a digital code from the authentication unit (18),
means for transmission, by the portable apparatus (16), via the secured mobile communication channel (22), to the authentication unit (18), of a sound signal generated from the digital code and transmitted by the automated teller machine (10),
means for authenticating the user by the authentication unit (18) using the sound signal received via the secured mobile communication channel (22) and an identifier of the user's portable apparatus (16), and
means for transmitting to the automated teller machine (10) an instruction to activate the automaton (28) to dispense banknotes corresponding to the predetermined amount.
